(19) United States
(12) Patent Application Publication
(10) Pub. No.: US 2005/0165177 A1
(43) Pub. Date: Jul. 28, 2005

(54) Method for producing highly functional, hyperbranched polyesters

(75) Inventors: Eva Wagner, Darmstadt (DE); Bernd Bruchmann, Freinsheim (DE); Peter Keller, Spiesen-Elversberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Lidwigshafen (DE)

(21) Appl. No.: 10/510,354

(22) PCT Filed: Apr. 22, 2003
(86) PCT No.: PCT/EP03/04121

(30) Foreign Application Priority Data
Apr. 30, 2002 (DE) 102 19 508.0

(51) Int. Cl. C08G 63/12

(52) U.S. Cl. 525/437

(57) ABSTRACT

A process for preparing high-functionality hyperbranched polyesters which comprises reacting (a) one or more dicarboxylic acids or one or more derivatives thereof with one or more at least trifunctional alcohols or (b) one or more tricarboxylic acids or higher polycarboxylic acids, or one or more derivatives thereof with one or more diols in the presence of a solvent and optionally in the presence of an inorganic, organometallic or low molecular mass organic catalyst.

The present invention relates to a process for preparing high-functionality hyperbranched polyesters which comprises reacting
(a) one or more dicarboxylic acids or one or more derivatives thereof with one or more at least trifunctional alcohols or
(b) one or more tricarboxylic acids or higher polycarboxylic acids or one or more derivatives thereof with one or more diols
   in the presence of a solvent and optionally in the presence of an inorganic, organometallic or organic catalyst.

The present invention further relates to high-functionality hyperbranched polyesters obtainable by the above-described process and to the use of the resultant high-functionality hyperbranched polyesters in coatings, paints, coverings and adhesives and also printing inks.

Modified high-functionality hyperbranched polyesters and dendrimers based on polyester are known per se—see for example WO 96/19537—and are already being used in certain applications, as impact modifiers for example. Dendrimers, however, are too expensive for general use, since the syntheses impose exacting requirements on yields of the molecular enlargement reactions and on purity of the intermediates and end products and require reagents too expensive for industrial use. The preparation of hyperbranched high-functionality polyesters prepared by conventional esterification reactions requires conditions which are usually fairly drastic—cf. WO 96/19537—such as high temperatures and/or strong acids. As a result there may be secondary reactions such as dehydration reactions and decarboxylations, for example, and as a consequence of the secondary reactions there may be unwanted instances of resinification and discoloration.

Known esterification processes which are able to take place under mild conditions include on the one hand those using very expensive activating reagents, such as dicyclohexyldicarbodiimide, and those using protective group chemistry, which is uneconomic in industrial reactions, however, and on the other hand enzymatic reactions, which, however, do not provide the desired products. For instance GB 2 272 904 discloses a process for the lipase-catalyzed preparation of a polyester by reacting at least one aliphatic dicarboxylic acid with at least one aliphatic diol or polyol or reacting at least one aliphatic hydroxycarboxylic acid with itself to form polyesters. The process is conducted at temperatures from 10 to 60° C., preferably at from 40 to 45° C., and even when using glycerol gives preferentially unbranched polyesters (page 3 lines 26/27). The process disclosed in GB 2 272 904 can therefore be used for the targeted synthesis of linear polymers. Pentaerythritol cannot be reacted in processes disclosed in GB 2 272 904 (page 3 line 28). The example demonstrates the synthesis of a linear polyester from adipic acid and butane-1,4-diol.

WO 94/12652 discloses a process for the enzyme-catalyzed synthesis of polyesters which is conducted in the absence of solvents (page 3 line 26). Two steps can be distinguished. In the first, oligomers are prepared enzymatically from diols and dicarboxylic acids or related products. Thereafter either the enzyme is recovered and the reaction is continued at elevated temperature or the enzyme is left in the reaction mixture and the temperature is raised, with the risk of possible irreversible destruction of the enzyme.

WO 98/55642 discloses a specific process for the enzyme-catalyzed synthesis of polyesters by reaction either of hydroxycarboxylic acids or else of aliphatic dicarboxylic acids with aliphatic diols or polyols and, optionally, an aliphatic hydroxycarboxylic acid in a two-stage process, in the first stage of which—optionally in the presence of water—the starting products are reacted in a molar ratio of from 1:1 to 1.1:1 and the second stage of which is conducted at elevated temperature. The process disclosed does not effect reaction of sterically hindered secondary hydroxyl groups (page 7 lines 27/28), with the secondary hydroxyl group of glycerol, for example, being classed as sterically hindered (page 8 line 4), so that reaction of glycerol gives linear products. WO 99/46397 discloses the synthesis of polyesters by reaction of, for example, a polyol having two primary and at least one secondary alcohol function(s) with one or more dicarboxylic or tricarboxylic acids in the presence of an effective amount of a lipase, carried out preferably under reduced pressure, so that linear polyesters are obtained. L. E. Iglesias et al. report in Biotechnology Techniques 1999, 13, 923, that linear polyesters are obtained by esterifying glycerol with adipic acid in the presence of an enzyme at 30° C. B. I. Kline et al. report in Polymer Mat. Sci. Eng. 1998, 79, 35, that linear polyesters are obtained by reacting glycerol with di-vinyladipate in the presence of an enzyme at 50° C.

The enzymatically catalyzed reactions described above, however, have the disadvantage that their progress is usually very slow. Thus the reaction times are generally from a large number of hours to several days.

Also known is the reaction of polyhydroxy compounds with polycarboxylic acids in the melt. Thus U.S. Pat. No. 4,749,728 describes a process for preparing a polyester from trimethylolpropane and adipic acid (OH:COOH 3:1) at 190° C. The process described is conducted in the absence of solvents and catalysts. The water or ethanol formed in the reaction is removed by simple distillation. The products obtained in this way can be reacted, for example, with epoxides and processed to thermosetting coating systems.

U.S. Pat. No. 4,880,980 discloses processes for preparing polyesters from trimethylolpropane and adipic acid, in which trimethylolpropane and adipic acid are heated under nitrogen in the absence of a solvent at 220° C. (reference example 8, column 8). The water formed during the reaction is discharged by introducing nitrogen into the melt.

EP-A 0 680 981 discloses a process for synthesizing polyester polyols which comprises heating a polyol, glycerol for example, and adipic acid in a ratio (OH:COOH 3:1) in the absence of catalysts and solvents at 150-160° C. Products are obtained which are suitable as a polyester polyol component of rigid polyurethane foams.

WO 98/17123 discloses a process for esterifying glycerol with adipic acid to form polymers which are used in chewing gum. They are obtained by a solvent-free process of esterification of glycerol with adipic acid at 150° C. (example A). No catalyst is used. After 4 hours gels begin to form. Gelatinous polyester polyols, however, are undesirable for numerous applications such as printing inks and adhesives, for example, since they can lead to the formation of lumps and they lessen the dispersing properties.

The products obtained by the processes described above are generally not very suitable for use as a component for adhesives or printing inks, since they are generally unwanted gelatinous products. In addition they are generally discolored, as a result of resinification, decarboxylation, intramolecular condensation reactions or similar unwanted secondary reactions. Finally the reaction mixtures generally have a high excess of OH groups relative to the COOH groups, so that the end products lack sufficient branching.

The object was therefore to provide a process for preparing high-functionality hyperbranched polyesters that avoids the disadvantages known from the prior art. A further object was to provide new high-functionality hyperbranched polyesters. Finally the object was to provide new uses for high-functionality hyperbranched polyesters.

It has now surprisingly been found that the object can be achieved by the process defined at the outset.

By the process of the invention are comprises reacting
(a) one or more dicarboxylic acids or one or more derivatives thereof with one or more at least trifunctional alcohols or
(b) one or more tricarboxylic acids or higher polycarboxylic acids or one or more derivatives thereof with one or more diols
   in the presence of a solvent and optionally in the presence of an inorganic, organometallic or low molecular mass organic catalyst.

High-functionality hyperbranched polyesters for the purposes of the present invention are molecularly and structurally nonuniform. As a result of their molecular nonuniformity they differ from dendrimers and can therefore be prepared with considerably less effort.

The dicarboxylic acids which can be reacted in accordance with version (a) include, for example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid and also cis- and trans-cyclopentane-1,3-dicarboxylic acid,
it being possible for the abovementioned dicarboxylic acids to be substituted by one or more radicals selected from
C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl,
C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl;
alkylene groups such as methylene or ethylidene or
C₆-C₁₄-aryl groups such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl.

As exemplary representatives of substituted dicarboxylic acids mention may be made of the following: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

The dicarboxylic acids which can be reacted in accordance with version (a) further include ethylenically unsaturated acids such as maleic acid and fumaric acid, for example, and also aromatic dicarboxylic acids such as phthalic acid, isophthalic acid or terephthalic acid, for example.

Mixtures of two or more of the aforementioned representatives can also be used.

The dicarboxylic acids can be used either as they are or in the form of derivatives.

By derivatives are meant preferably
the corresponding anhydrides in monomeric or else polymeric form,
mono- or dialkyl esters, preferably mono- or dimethyl esters or the corresponding mono- or diethyl esters, but also the mono- and dialkyl esters derived from higher alcohols such as n-propanol, isopropanol, n-butanol, isobutanol, tert-butanol, n-pentanol and n-hexanol, for example,
additionally mono- and divinyl esters, and also
mixed esters, preferably methyl ethyl esters.

In the context of the present invention it is also possible to use a mixture of dicarboxylic acid and one or more of its derivatives. Likewise it is possible in the context of the present invention to use a mixture of two or more different derivatives of one or more dicarboxylic acids.

Particular preference is given to using succinic acid, glutaric acid, adipic acid, phthalic acid, isophthalic acid, terephthalic acid or their mono- or dimethyl esters. Very particular preference is given to using adipic acid.

At least trifunctional alcohols which can be reacted include for example the following: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or di-trimethylolpropane, trimethylolethane, pentaerythritol or dipentaerythritol; sugar alcohols such as mesoerythritol, threitol, sorbitol, mannitol, for example, or mixtures of the above at least trifunctional alcohols. Preference is given to using glycerol, trimethylolpropane, trimethylolethane and pentaerythritol.

Tricarboxylic acids or polycarboxylic acids which can be reacted in accordance with version (b) are, for example, 1,2,4-benzenetricarboxylic acid, 1,3,5-benzenetricarboxylic acid, 1,2,4,5-benzenetetracarboxylic acid and also mellitic acid.

In the reaction according to the invention tricarboxylic acids or polycarboxylic acids can be used either as they are or else in the form of derivatives.

By derivatives are meant preferably
the corresponding anhydrides in monomeric or else polymeric form,
mono-, di- or trialkyl esters, preferably mono-, di- or trimethyl esters or the corresponding mono-, di- or triethyl esters, but also the mono- di- and triesters derived from higher alcohols such as n-propanol, isopropanol, n-butanol, isobutanol, tert-butanol, n-pentanol and n-hexanol, for example, and also mono-, di- or trivinyl esters,
and also mixed methyl ethyl esters.

In the context of the present invention it is also possible to use a mixture of a tricarboxylic or polycarboxylic acid and one or more of its derivatives. Likewise it is possible in the context of the present invention to use a mixture of two or more different derivatives of one or more tricarboxylic or polycarboxylic acids.

As diols for version (b) of the present invention use is made for example of ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representatives of the above compounds, n being an integer and n=4. One or else both of the hydroxyl groups in the aforementioned diols can also be substituted by SH groups. Preference is given to ethylene glycol, propane-1,2-diol and also diethylene glycol, triethylene glycol, dipropylene glycol and tripropylene glycol.

The molar ratio of hydroxyl groups to carboxyl groups in the case of versions (a) and (b) are from 2:1 to 1:2, in particular from 1.5:1 to 1:1.5.

The at least trifunctional alcohols which are reacted in accordance with version (a) of the process of the invention may have hydroxyl groups each of equal reactivity. Preference is also given here to at least trifunctional alcohols whose OH groups are initially of equal reactivity but in which by reaction with at least one acid group it is possible to induce a drop in reactivity, caused by steric or electronic influences, among the remaining OH groups. This is the case, for example, when trimethylolpropane or pentaerythritol is used.

The at least trifunctional alcohols which are reacted in accordance with version (a) of the process of the invention may also, however, contain hydroxyl groups having at least two chemically different reactivities.

The different reactivity of the functional groups may derived either from chemical causes (e.g., primary/secondary/tertiary OH group) or from steric causes.

By way of example the triol may be a triol which contains primary and secondary hydroxyl groups: a preferred example is glycerol.

When carrying out the inventive reaction in accordance with version (a) it is preferred to operate in the absence of diols and monofunctional alcohols.

When carrying out the inventive reaction in accordance with version (b) it is preferred to operate in the absence of monocarboxylic or dicarboxylic acids.

The process of the invention is conducted in the presence of a solvent. Suitable examples include hydrocarbons such as paraffins or aromatics. Particularly suitable paraffins are n-heptane and cyclohexane. Particularly suitable aromatics are toluene, ortho-xylene, meta-xylene, para-xylene, xylene isomer mixture, ethylbenzene, chlorobenzene and ortho- and meta-dichlorobenzene. Additional solvents which are especially suitable in the absence of acidic catalysts include the following: ethers such as dioxane or tetrahydrofuran and ketones such as methyl ethyl ketone and methyl isobutyl ketone, for example.

The amount of added solvent is in accordance with the invention at least 0.1% by weight, based on the mass of the starting materials to be reacted that are used, preferably at least 1% by weight and more preferably at least 10% by weight. It is also possible to employ excesses of solvent, based on the mass of starting materials to be reacted that are employed, such as from 1.01 to 10 times, for example. Solvent amounts of more than 100 times, based on the mass of starting materials to be reacted that are employed, are not advantageous, since at significantly lower concentrations of the reactants the reaction rate falls markedly, leading to uneconomically long reaction times.

To carry out the process of the invention it is possible to operate in the presence of a water remover additive which is added at the beginning of the reaction. Suitable examples include molecular sieves, particularly molecular sieve 4 Å, MgSO₄ and Na₂SO₄. It is also possible during the reaction to add further water remover additive or to replace water remover additive by fresh water remover additive. It is also possible to distill off water or alcohol formed during the reaction and to use, for example, a water separator.

The process of the invention can be conducted in the absence of acidic catalysts. It is preferred to operate in the presence of an acidic inorganic, organometallic or organic catalyst or mixtures of two or more acidic inorganic, organometallic or organic catalysts.

Acidic inorganic catalysts for the purposes of the present invention include for example sulfuric acid, phosphoric acid, phosphonic acid, hypophosphorous acid, aluminum sulfate hydrate, alum, acidic silica gel (pH=6, in particular =5) and acidic alumina. Also possible for use are, for example, alumium compounds of the general formula Al(OR)₃ and titanates of the general formula Ti(OR)₄ as acidic inorganic catalysts, the radicals R each being able to be identical or different and being chosen independently of one another from
C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl,
C₃-C₁₂-cycloalkyl radicals, examples being cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl.

Preferably the radicals R in Al(OR)₃ and Ti(OR)₄ are each identical and chosen from isopropyl or 2-ethylhexyl.

Preferred acidic organometallic catalysts are chosen for example from dialkyltin oxides R₂SnO, where R is as defined above. One particularly preferred representative of acidic organometallic catalysts is di-n-butyltin oxide, available commercially in the form of oxo-tin.

Preferred acidic organic catalysts are acidic organic compounds containing, for example, phosphate groups, sulfonic acid groups, sulfate groups or phosphonic acid groups. Particular preference is given to sulfonic acids such as para-toluenesulfonic acid, for example. Acidic ion exchangers can also be used as acidic organic catalysts, examples being polystyrene resins which contain sulfonic acid groups and have been crosslinked with about 2 mol % of divinylbenzene.

Combinations of two or more of the aforementioned catalysts can also be used. Another possibility is to use those organic or organometallic or else inorganic catalysts which are in the form of discrete molecules, in an immobilized form.

If the use of acidic inorganic, organometallic or organic catalysts is desired, the amount of catalyst used in accordance with the invention is from 0.1 to 10% by weight, preferably from 0.2 to 2% by weight.

Enzymes or decomposition products of enzymes are not included among the acidic organic catalysts for the purposes of the present invention. Similarly the dicarboxylic acids reacted in accordance with the invention are not among the acidic organic catalysts for the purposes of the present invention.

For conducting the process of the invention it is advantageous to forego the use of enzymes.

The process of the invention is carried out under an inert gas atmosphere: that is, for example, under carbon dioxide, nitrogen or noble gas, among which argon in particular may be mentioned.

The process of the invention is conducted at temperatures of from 80 to 200° C. It is preferred to operate at temperatures of from 130 to 180° C., in particular up to 150° C. or below. Particular preference is given to maximum temperatures up to 145° C., very preferably up to 135° C.

The pressure conditions of the process of the invention are not critical per se. It is possible to operate at a considerably reduced pressure, at from 10 to 500 mbar, for example. The process of the invention can also be conducted at pressures above 500 mbar. For reasons of simplicity it is preferred to carry out the reaction at atmospheric pressure, although it can also be carried out at a slightly elevated pressure, up to 1200 mbar, for example. Working under a significantly increased pressure is a further possibility, at pressures up to 10 bar, for example. Reaction at atmospheric pressure is preferred.

The reaction time of the process of the invention is usually from 10 minutes to 25 hours, preferably from 30 minutes to 10 hours and more preferably from one to 8 hours.

After the end of the reaction the high-functionality hyperbranched polyesters can be isolated easily, for example, by removing the catalyst by filtration and concentrating the filtrate, usually under reduced pressure. Further highly suitable workup methods include precipitation following the addition of water and subsequent washing and drying.

The present invention further provides the high-functionality hyperbranched polyesters obtainable by the process of the invention. They are distinguished by particularly low fractions of discoloration and resinification. Regarding the definition of the hyperbranched polymers see also: P. J. Flory, J. Am. Chem. Soc. 1952, 74, 2718 and A. Sunder et al., Chem. Eur. J. 2000, 6, No. 1, 1-8. By “high-functionality hyperbranched” is meant in connection with the present invention, however, that branching is present in from 30 to 70 mol %, preferably from 40 to 60 mol %, of each monomer unit.

The polyesters of the invention have a molecular weight M_{w} of from 2000 to 50 000 g/mol, preferably from 3000 to 20 000, more preferably from 3000 to 7000 and very preferably 4000 g/mol. The polydispersity is from 1.2 to 50, preferably from 1.4 to 40, more preferably from 1.5 to 30 and very preferably up to 10. They are usually thus readily soluble; that is, clear solutions can be prepared with up to 50% by weight, in some cases even up to 80% by weight, of the polyesters of the invention in tetrahydrofuran (THF), n-butyl acetate, ethanol and numerous other solvents, without gel particles being detectable to the naked eye.

The high-functionality hyperbranched polyesters of the invention are carboxy-terminated, carboxy- and hydroxyl-terminated and, preferably, hydroxyl-terminated and can be used with advantage for preparing, for example, adhesives, printing inks, coatings, foams, coverings and paints.

A further aspect of the present invention is the use of the high-functionality hyperbranched polyesters of the invention for preparing polyaddition products or polycondensation products, examples being polycarbonates, polyurethanes and polyethers. Preference is given to the use of the hydroxyl-terminated high-functionality hyperbranched polyesters of the invention for preparing polyaddition products or polycondensation products polycarbonates or polyurethanes.

A further aspect of the present invention is the use of the high-functionality hyperbranched polyesters of the invention and also of the polyaddition products or polycondensation products prepared from high-functionality hyperbranched polyesters as a component of adhesives, coatings, foams, coverings and paints. A further aspect of the present invention are printing inks, adhesives, coatings, foams, coverings and paints comprising the high-functionality hyperbranched polyesters of the invention or polyaddition products or polycondensation products prepared from the high-functionality hyperbranched polyesters of the invention. They are distinguished by outstanding performance properties.

A further preferred aspect of the present invention are printing inks, especially packaging inks for flexographic and/or gravure printing, which comprises at least one solvent or a mixture of different solvents, at least one colorant, at least one polymeric binder and, optionally, further additives, at least one of the polymeric binders being a hyperbranched high-functionality polyester of the invention.

In the context of the present invention the hyperbranched polyesters of the invention can also be used in a mixture with other binders. Examples of further binders for the printing inks of the invention include polyvinylbutyral, nitrocellulose, polyamides, polyacrylates or polyacrylate copolymers. The combination of the hyperbranched polyesters with nitrocellulose has proven particularly advantageous. The total amount of all binders in the printing ink of the invention is usually 5-35% by weight, preferably 6-30% by weight and more preferably 10-25% by weight, based on the sum of all the constituents. The ratio of hyperbranched polyester to the total amount of all binders is usually in the range from 30% by weight to 100% by weight, preferably at least 40% by weight, but the amount of hyperbranched polyester should generally not be below 3% by weight, preferably 4% by weight and more preferably 5% by weight relative to the sum of all the constituents of the printing ink.

It is possible to employ an individual solvent or else a mixture of two or more solvents. Solvents suitable in principle are the customary solvents for printing inks, especially packaging inks. Particularly suitable solvents for the printing ink of the invention are alcohols such as, for example, ethanol, 1-propanol, 2-propanol, ethylene glycol, propylene glycol, diethylene glycol, substituted alcohols such as ethoxypropanol, for example, esters such as ethyl acetate, isopropyl acetate, n-propyl or n-butyl acetate, for example. A further solvent suitable in principle is water. A particularly preferred solvent is ethanol or mixtures composed predominantly of ethanol. Among the solvents possible in principle the person skilled in the art will make an appropriate selection in accordance with the solubility properties of the polyester and with the desired properties of the printing ink. It is usual to use from 40 to 80% by weight of solvent relative to the sum of all the constituents of the printing ink.

Colorants which can be used are the customary dyes, in particular customary pigments. Examples are inorganic pigments such as titanium dioxide pigments or iron oxide pigments, interference pigments, carbon blacks, metal powders such as particularly aluminum, brass or copper powder, and also organic pigments such as azo, phthalocyanine or isoindoline pigments. As will be appreciated, it is also possible to use mixtures of different dyes or colorants and also soluble organic dyes. It is usual to use from 5 to 25% by weight of colorant, relative to the sum of all the constituents.

The packaging ink of the invention may optionally comprise further additives and auxiliaries. Examples of additives and auxiliaries are fillers such as calcium carbonate, aluminum oxide hydrate or aluminum silicate or magnesium silicate. Waxes increase the abrasion resistance and serve to enhance the lubricity. Particular examples are polyethylene waxes, oxidized polyethylene waxes, petroleum waxes or ceresin waxes. Fatty acid amides can be used to raise the surface smoothness. Plasticizers increase the elasticity of the dried film. Examples are phthalic esters such as dibutyl phthalate, diisobutyl phthalate, dioctyl phthalate, citric esters or esters of adipic acid. Dispersing assistants can be used to disperse the pigments. In the case of the printing ink of the invention it is possible with advantage to do without adhesion promoters, although this is not intended to indicate that the use of adhesion promoters should be ruled out absolutely. The total amount of all additives and auxiliaries normally does not exceed 20% by weight, relative to the sum of all of the constituents of the printing ink, and is preferably 0-10% by weight.

The packaging ink of the invention can be prepared in a way which is known in principle, by intensive mixing and/or dispersing of the constituents in customary apparatus such as, for example, dissolvers, stirred bore mills or a triple-roll mill. It is advantageous first to prepare a concentrated pigment dispersion with one portion of the components and one portion of the solvent, and later to process this dispersion further to the finished printing ink with further constituents and further solvent.

Another preferred aspect of the present invention are print varnishes which comprise at least one solvent or a mixture of different solvents, at least one polymeric binder and, optionally, further additives, at least one of the polymeric binders being a hyperbranched high-functionality polyester of the invention, and also the use of the print varnishes of the invention for priming, as a protective varnish and for producing multilayer materials.

The print varnishes of the invention of course contain no colorants, but apart from that have the same constituents as the printing inks of the invention already described. The amounts of the other components increase accordingly.

Surprisingly, through the use of printing inks, especially packaging inks, and print varnishes with binders based on hyperbranched polyesters, multilayer materials which feature excellent adhesion between the individual layers are obtained. The addition of adhesion promoters is no longer necessary. Particularly surprising in this context is that without adhesion promoters it is possible to obtain results even better than those when adhesion promoters are added. On polar films in particular it has been possible to bring about a distinct improvement in the adhesion.

The invention is illustrated by working examples. The analytical data of the polyesters of the invention can be found in table 1.

### EXAMPLE 1

In a 2 l four-necked flask equipped with a water separator adipic acid (702 g, 4.8 mol) and trimethylolpropane (537 g, 4.0 mol) and also di-n-butyltin oxide, available commercially as Fascat® (2.4 g, 4201 E-Coat, elf atochem) were heated at 125 to 130° C. in toluene (200 g) under nitrogen. After a reaction time of 11 h the toluene was distilled off under reduced pressure. This gave a colorless, viscous polyester which was readily soluble in, for example, butyl acetate and THF.

### EXAMPLE 2

In a 2 l four-necked flask equipped with a water separator adipic acid (526 g, 3.6 mol) and trimethylolpropane (537 g, 4.0 mol) and also Fascat® (2.1 g) were heated at 125 to 140° C. in toluene (200 g) under nitrogen. After a reaction time of 25 h the toluene was distilled off under reduced pressure. This gave a colorless, viscous polyester.

### EXAMPLE 3

10 Example 1 was repeated but the amount of adipic acid (351 g, 2.4 mol), trimethylolpropane (268 g, 2.0 mol) and toluene (100 g) was halved and the catalyst used was tetra(2-ethylhexyl) titanate (1.2 g) rather than di-n-butyltin oxide (Fascat®). After a reaction time of 6 h the toluene was distilled off under reduced pressure. This gave a colorless polyester, η=54 500 mPa·s (50° C.).

### EXAMPLE 4

In a 1 l four-necked flask equipped with a water separator adipic acid (351 g, 2.4 mol), trimethylolpropane (268 g, 2.0 mol) and toluene (20 g) were mixed thoroughly and heated at 150° C., during which the water of reaction formed was removed by distillation. After a reaction time of 3 h the toluene was distilled off under reduced pressure. This gave a colorless, viscous polyester.

### EXAMPLE 5

In a 2 l four-necked flask equipped with a water separator adipic acid (877 g, 6.0 mol) were reacted with glycerol (461 g, 5.0 mol) in the presence of di-n-butyltin oxide (Fascat®) (3 g) under nitrogen in toluene (200 g) for 6 hours at 130° C. with one another. This gives a product which is readily soluble in ethanol and in n-butyl acetate,
η=66 700 mPa·s (50° C.)

### EXAMPLE 6

In a 1 l four-necked flask equipped with a water separator azelaic acid (94 g, 0.5 mol) together with trimethylolpropane (67 g, 0.5 mol) were dissolved in toluene (20 g) under nitrogen. Following the addition of di-n-butyltin oxide (Fascat®, 0.32 g) the mixture was heated at 135-140° C. for 9 h, during which the water of reaction was removed. After cooling to room temperature and distillative removal of the remaining toluene, colorless polyester was obtained.

TABLE 1
Reaction parameters of examples 1 to 6 and analytical
data of the polyesters obtained

| | | | Analytical data of the polyesters | | | | |
|---|---|---|---|---|---|---|---|
| | Carboxyl:OH | | | | | Acid number | |
| | ratio at beginning | | | | Mₙ/ | [mg KOH/g | OH |
| No. | of esterification | | Mₙ | M_{w} | M_{w} | polyester] | number |
| 1 | 1.85 | 1 | 1620 | 16170 | 10.0 | 77 | 190 |
| 2 | 0.9 | 1 | 1860 | 16380 | 8.8 | 21 | 309 |
| 3 | 1.85 | 1 | 1300 | 6370 | 4.9 | 100 | 226 |
| 4 | 1.85 | 1 | 645 | 4453 | 6.9 | 113 | n.d. |
| 5 | 0.8 | 1 | 1810 | 17730 | 9.8 | 100 | n.d. |
| 6 | 1 | 1.5 | 930 | 1671 | 1.8 | 56 | n.d. |

The acid number was determined in accordance with DIN 53402. M_{w} was determined by GPC in THF by means of polystyrene calibration.
n.d.: not determined

1. A process for preparing high-functionality hyperbranched polyesters which comprises reacting
(a) one or more dicarboxylic acids or one or more derivatives thereof with one or more at least trifunctional alcohols or
(b) one or more tricarboxylic acids or higher polycarboxylic acids, or one or more derivatives thereof with one or more diols
in the presence of a solvent and optionally in the presence of an acidic inorganic, organometallic or organic catalyst.

2. The process according to claim 1, wherein the process comprises reacting
(a) one or more dicarboxylic acids or one or more derivatives thereof with one or more at least trifunctional alcohols and
said at least trifunctional alcohol comprises hydroxyl groups of at least two chemically different reactivities.

3. The process according to claim 1, wherein the process comprises reacting
(a) one or more dicarboxylic acids or one or more derivatives thereof with one or more at least trifunctional alcohols and
said at least trifunctional alcohol comprises hydroxyl groups each of chemically identical reactivity.

4. The process according to claim 1, wherein the process comprises reacting
(b) one or more tricarboxylic acids or higher polycarboxylic acids, or one or more derivatives thereof with one or more diols and
said at least one tricarboxylic acid or polycarboxylic acid comprises carboxyl groups of at least two different reactivities.

5. The process according to claim 1, wherein the process comprises reacting
(a) one or more dicarboxylic acids or one or more derivatives thereof with one or more at least trifunctional alcohols and
said trifunctional alcohol comprises glycerol.

6. The process according to claim 1, wherein the process comprises reacting
(a) one or more dicarboxylic acids or one or more derivatives thereof with one or more at least trifunctional alcohols and
said trifunctional alcohol comprises trimethylolpropane.

7. The process according to claim 1, wherein the derivatives of dicarboxylic, tricarboxlic or polycarboxylic acids comprise methyl esters or ethyl esters.

8. The process according to claim 1, wherein water, methanol and/or ethanol formed during the reaction is removed from the reaction equilibrium.

9. The process according to claim 1, wherein the solvent comprises toluene.

10. A high-functionality hyperbranched polyester obtained by the process according to claim 1.

11. (canceled)

12. A printing ink, an adhesive, a coating, a paint, or a covering comprising the high-functionality hyperbranched polyester as claimed in claim 10.
